(19) United States
(12) Patent Application Publication
(10) Pub. No.: US 2023/0341276 A1
(43) Pub. Date: Oct. 26, 2023

(54) Roofing Membrane Bond Indicator

(71) Applicant: Chromatic Technologies, Inc., Colorado Springs, CO (US)

(72) Inventors: Timothy J. Owen, Colorado Springs, CO (US); Ruizheng Wang, Colorado Springs, CO (US); Medhanei Abraha, Colorado Springs, CO (US)

(73) Assignee: Chromatic Technologies, Inc., Colorado Springs, CO (US)

(21) Appl. No.: 17/797,901

(22) PCT Filed: Feb. 5, 2021
(86) PCT No.: PCT/US21/16927

§ 371 Date: Aug. 5, 2022

Related U.S. Application Data
(60) Provisional application No. 62/971,544, filed on Feb. 7, 2020.

(51) Int. Cl. G01K 11/16; E04D 5/06; E04D 5/14; C09D 5/26; C09D 11/50; C09D 11/037; C09D 11/033; C09D 7/40

(52) U.S. Cl. CPC G01K 11/16; E04D 5/06; E04D 5/149; C09D 5/26; C09D 11/50; C09D 11/037; C09D 11/033; C09D 7/69; C09D 7/70; C08K 9/10

(57) ABSTRACT

A thermochromic indicator and its use for visually determining whether adjacent surfaces of overlapping edge portions of side-by-side roofing membrane segments have been sufficiently heated to a preselected temperature threshold to achieve a desired weld therebetween to correspondingly seal the roofing membrane seam.

This application is the United States National Stage of International Patent Cooperation Treaty Patent Application No. PCT/US21/16927, filed Feb. 5, 2021, which claims the benefit of U.S. Provisional Patent Application No. 62/971,544, filed Feb. 7, 2020, each hereby incorporated by reference herein.

### I. BACKGROUND

Thermoplastic roofing membranes have become prominent products in the construction industry for protecting roofs. These roofing membranes are typically manufactured as elongate sheets having a width of about five feet or greater, whereby such a sheet can be provided in a roll. Following, the roofing membrane can be unrolled on a roof in segments, and edge portions of side-by-side roofing membrane segments can overlap, forming a roofing membrane seam. The overlapping edge portions can be welded together proximate the roofing membrane seam to form a seal; as a result, the roofing membrane segments can function as one monolithic layer of material impervious to water and moisture infiltration.

For continuous and steadfast sealing, the overlapping edge portions of side-by-side roofing membrane segments can be welded by heating the adjacent surfaces of the overlapping edge portions and then pressing the heated surfaces together, merging the material of the roofing membrane segments to provide the requisite seal. The integrity of the seal and correspondingly, of the overall roof, can depend upon appropriate and sufficient heat application to achieve melting of the adjacent surfaces of the overlapping edge portions to generate an uninterrupted seal between the roofing membrane segments.

One approach to ensuring a membrane-to-membrane seal can be the intentional excess application of heat. While this may achieve an adequate seal, the process can be relatively slow, as the application of a greater amount of heat can take longer than the application of the appropriate, lesser amount of heat. Additionally, excess heat application may result in damage to the roofing membrane, which can shorten its service life. Furthermore, such methodology may be energy inefficient.

Another tactic to ensure seal integrity can involve checking the seal, either visually or mechanically and either on a spot or continuous basis, by manually lifting the edge of the upper roofing membrane segment to determine if it is properly welded to the lower roofing membrane segment. Of course, spot checks can miss unexamined unsealed areas, and inspection of every roofing membrane seam may be time consuming and therefore costly.

Accordingly, a means for providing an easily observable, positive indication of sufficient heat exposure and thus, appropriate sealing of a roofing membrane seam may be highly desirable.

### II. DISCLOSURE OF THE INVENTION

A broad object of a particular embodiment of the invention can be to provide a thermochromic indicator for visually determining whether a roofing membrane has been sufficiently heated to a preselected temperature threshold to seal a roofing membrane seam, the thermochromic indicator including a contained reversible color-changing system having a dye, a developer, and a solvent, whereby the developer variably interacts with the dye according to the temperature of the color-changing system. Prior to use, the color-changing system can be activated to form a visibly-colored dye-developer complex. In use, upon exposure to the preselected temperature threshold, the dye-developer complex can dissociate, resulting in a visible color change. Further, the visible color change can be retained upon a decrease in temperature from the temperature threshold, thereby effectively recording the exposure to the temperature threshold.

Another broad object of a particular embodiment of the invention can be to provide a method of using the thermochromic indicator coupled to a roofing membrane for visually determining whether adjacent surfaces of overlapping edge portions of side-by-side roofing membrane segments have been sufficiently heated to a preselected temperature threshold to achieve a desired weld therebetween to correspondingly seal the roofing membrane seam.

Naturally, further objects of the invention are disclosed throughout other areas of the specification, drawings, photographs, and claims.

### III. BRIEF DESCRIPTION OF THE DRAWINGS

FIG. 1A is an illustration of a particular embodiment of the instant thermochromic indicator coupled to an upper roofing membrane segment, whereby an edge portion of the upper roofing membrane segment is shown overlaying an edge portion of a lower roofing membrane segment. In this illustration, the edge portions are not yet welded.

FIG. 1B is an illustration of the thermochromic indicator shown in FIG. 1A, but whereby adjacent surfaces of the overlapping edge portions have been sufficiently heated to a preselected temperature threshold and correspondingly, welded.

FIG. 2A is an illustration of a particular embodiment of the instant thermochromic indicator coupled to a roofing membrane, whereby the thermochromic indicator has not yet been exposed to the preselected temperature threshold.

FIG. 2B is an illustration of the temperature indicator shown in FIG. 2A, but whereby the temperature indicator has been exposed to the preselected temperature threshold; consequently, the thermochromic indicator has undergone a visible color change.

FIG. 2C is an illustration of the temperature indicator shown in FIG. 2B after the temperature has decreased from the temperature threshold to ambient temperature. The thermochromic indicator has retained the color change due to the color-memory property of the color-changing system.

FIG. 3A is an enlarged and exaggerated view of a portion of the thermochromic indicator shown in FIG. 2A, whereby components of the encapsulated reversible color-changing system are illustrated.

FIG. 3B is an enlarged and exaggerated view of a portion of the thermochromic indicator shown in FIG. 2B, whereby components of the encapsulated reversible color-changing system are illustrated.

FIG. 3C is an enlarged and exaggerated view of a portion of the thermochromic indicator shown in FIG. 2C, whereby components of the encapsulated reversible color-changing system are illustrated.

FIG. 4A is an enlarged and exaggerated view of a particular embodiment of the instant thermochromic indicator configured as ink including the encapsulated reversible color-changing system, whereby the color-changing system has not yet been exposed to the preselected activation temperature.

FIG. 4B is an illustration of the ink shown in FIG. 4A, but whereby the color-changing system has been exposed to the activation temperature; consequently, the color-changing system has undergone a visible color change.

FIG. 4C is an illustration of the ink shown in FIG. 4B being printed onto a roofing membrane.

FIG. 5 is an illustration of hysteresis characteristics of a particular embodiment of the instant reversible color-changing system which has a color-memory property.

FIG. 6 is a photograph of a particular embodiment of the instant thermochromic indicator configured as ink including the encapsulated reversible color-changing system, whereby the ink is being printed onto a roofing membrane via a slot-die coater.

FIG. 7 is a photograph of the roofing membrane shown in FIG. 6 having the instant thermochromic indicator printed thereon, whereby the roofing membrane is being coiled into a roll.

FIG. 8 is a photograph of the roofing membrane shown in FIGS. 6 and 7 having the instant thermochromic indicator printed thereon, whereby the roofing membrane is being exposed to the preselected temperature threshold via a heat gun from left to right. Correspondingly, the thermochromic indictor is undergoing a visible color change from blue to colorless.

### IV. MODE(S) FOR CARRYING OUT THE INVENTION

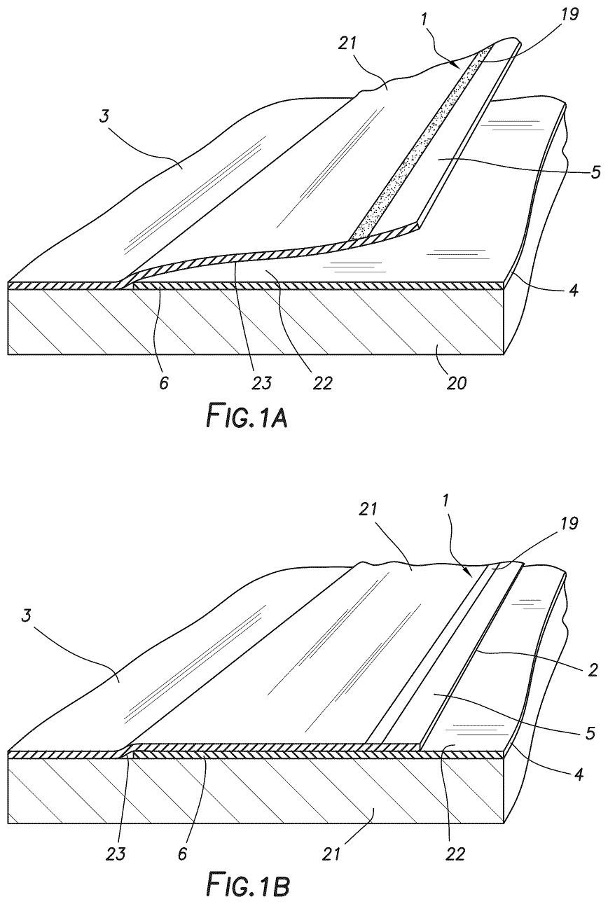

Now referring primarily to FIGS. 1A and 1B, which illustrate a method of using a particular embodiment of the inventive thermochromic indicator (1) for visually determining whether a roofing membrane seam (2) formed by overlapping edge portions of upper and lower roofing membrane segments (3)(4), namely an upper roofing membrane segment edge portion (5) and a lower roofing membrane segment edge portion (6), has been sufficiently heated to a preselected temperature threshold (7) to weld adjacent surfaces of the edge portions (5)(6) and correspondingly, seal the roofing membrane seam (2).

As to particular embodiments, the thermochromic indicator (1) can be coupled to a roofing membrane upper surface (8) and can include a contained reversible color-changing system (9) comprising a dye (10), a developer (11), and a solvent (12), whereby the developer (11) variably interacts with the dye (10) according to the temperature of the color-changing system (9). For example, prior to the instant use, the reversible color-changing system (9) can be activated to form a visibly-colored dye-developer complex (13). In use, upon exposure to the preselected temperature threshold (7), the dye-developer complex (13) can dissociate, resulting in a visually perceptible color change.

Accordingly, the method of use can include detecting whether or not a visible color change occurred, for example by visually observing the thermochromic indicator (1) coupled to the roofing membrane upper surface (8), whereby visual detection of a visible color change resulting from dissociation of the dye (10) and the developer (11) indicates that adjacent surfaces of the overlapping edge portions (5)(6) of upper and lower roofing membrane segments (3)(4) have been exposed to the preselected temperature threshold (7) and correspondingly, are sufficiently welded proximate the roofing membrane seam (2). Conversely, visual detection of the absence of a visible color change, meaning no visible color change occurred, indicates that adjacent surfaces of the overlapping edge portions (5)(6) of upper and lower roofing membrane segments (3)(4) have not been exposed to the preselected temperature threshold (7) and correspondingly, may not be sufficiently welded proximate the roofing membrane seam (2).

### Definitions

As used herein, the term “indicator” means a composition or an apparatus which indicates or signifies or points out or makes known or shows that a predetermined event has occurred.

As used herein, the term “contained” indicates that the dye (10), the developer (11), and the solvent (12) are continuously kept within a physical proximity which allows interaction between the components. Additionally, by being contained, the reversible color-changing system (9) is separated from the external environment, which may damage or destroy the color-changing system (9).

As used herein, the term “preselected” means predetermined or decided in advance.

As used herein, the term “threshold” means the point which must be obtained or exceeded for a certain phenomenon to occur or be manifested.

As used herein, the term “dye” means a chemical compound which can change color, such as a color former which is capable of reacting with the instant developer (11) to form a dye-developer complex (13) which exhibits optical properties that can be discerned by the human eye.

As used herein, the term “developer” means a chemical compound which is capable of reacting with the instant dye (10) to form a dye-developer complex (13) which exhibits optical properties that can be discerned by the human eye. The term “developer” can be synonymous with “color developer,” both meaning a chemical compound which facilitates a change in color of the dye (10).

As used herein, the term “solvent” can, but need not necessarily, be synonymous with phase-change material, whereby phase-change material is herein defined simply as a material which changes from one phase to another.

As used herein, the term “detect” and forms thereof means to discover or ascertain the presence of.

As used herein, the term “weld” means unite or join or bond or melt together, such as via heat.

As used herein, the term “color” excludes white, correspondingly meaning any color other than white.

### Dye and Developer

The instant contained color-changing system (9) can be a reversible color-changing system, meaning that the temperature-modulated visible color change can be reversible, as opposed to an irreversible color change or a permanent color change.

Following, as to particular embodiments, the dye (10) of the instant reversible color-changing system (9) can comprise a leuco dye (10) which can reversibly change between two forms, one of which is typically colorless (or substantially colorless).

It may be advantageous to use a leuco dye (10) for the instant application, as opposed to a dye which changes from one color to another color, because once changed to the colorless state upon exposure to the preselected temperature threshold (7), the leuco dye (10) and correspondingly, the thermochromic indicator (1), may appear effectively invisible on the sealed roofing membrane (14), which may be more be desirable (for functional and/or aesthetic purposes) than a sealed roofing membrane (14) having a plurality of colored stripes thereon.

As but only a few non-limiting examples for the purpose of illustration, the leuco dye (10) can be: crystal violet lactone (CAS No.: 1552-42-7); Pigment Blue 63 (CAS No.: 16521-38-3); 2′-(dibenzylamino)-6′-(diethylamino)fluoran (CAS No.: 34372-72-0); 7-(4-(Diethylamino)-2-ethoxyphenyl)-7-(1-ethyl-2-methyl-1H-indol-3-yl)furo[3,4-b]pyridin-5(7H)-one (CAS No.: 69898-40-4); 6′-(diethylamino)-1′,3′-dimethylfluoran (CAS No.: 21934-68-9); 3,3-bis(1-butyl-2-methyl-1H-indol-3-yl)phthalide (CAS No.: 50292-91-6); combinations thereof; or the like.

As to particular embodiments, the leuco dye (10) can be an electron-donating compound (or proton-accepting compound). Further, the developer (11) can comprise an electron-accepting compound (or proton-donating compound), such as an acid and particularly, a weak acid. Upon interaction (specifically, an electron transfer reaction) between the electron-donating leuco dye (10) and the electron-accepting developer (11), the leuco dye (10) reversibly changes color, for example from colorless to visibly colored.

As but only a few non-limiting examples for the purpose of illustration, the developer (11) can be: 3,5-di-tert-butylcatechol (CAS No.: 1020-31-1); 4,4′-(1,3-dimethylbutylidene)diphenol (CAS No.: 6807-17-6); 2,2′-biphenol (CAS No.: 1806-29-7); or the like.

Without being bound by any particular theory of operation, it is believed that within the instant reversible color-changing system (9), depending upon the temperature of the color-changing system (9), the developer (11) can reversibly interact with the leuco dye (10) via an electron transfer reaction to open up the lactone ring of the leuco dye (10) and stabilize the opened structure, forming a supramolecular visibly-colored dye-developer complex (13). When open, the lactone ring is cationic in nature, thereby extending conjugation of its π electrons and allowing absorption in the visible spectrum to provide the visibly-colored dye-developer complex (13), whereby the stability of the dye-developer complex (13) is determined, at least in part, by the affinity of the developer (11) for the leuco dye (10).

### Solvent

The instant reversible color-changing system (9) further includes a solvent (12) which effects or controls the reversible interaction between the leuco dye (10) and the developer (11).

As to particular embodiments, a solvent (12) which may be useful with the instant reversible color-changing system (9) can be (i) a solvent (12) in which both the leuco dye (10) and the developer (11) are soluble, and (ii) a solvent (12) which is capable of being contained along with the leuco dye (10) and the developer (11), for example within a capsule (or microcapsule) (15) to provide a corresponding encapsulated reversible color-changing system (9). When contained within the capsule (15), the solvent (12) can facilitate the interaction between the leuco dye (10) and the developer (11).

As to particular embodiments, the solvent (12) can be a hydrocarbon.

As to particular embodiments, the solvent (12) can be a ketone.

As to particular embodiments, the ketone can have formula I as follows:

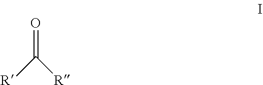

As to particular embodiments, the ketone can have formula I, whereby R′ and R″ can be either the same or different, and R′ and R″ can be (i) a straight-chain, branched, or cyclic alkyl group, (ii) a straight-chain, branched, or cyclic alkenyl group, (iii) a straight-chain, branched, or cyclic alkynyl group, (iv) an aryl group, or (v) a heteroaryl group, whereby any of the groups can be unsubstituted or substituted.

As to particular embodiments, the solvent (12) can be an ester.

As to particular embodiments, the ester can have formula II as follows:

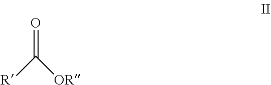

As to particular embodiments, the ester can have formula II, whereby R′ and R″ can be either the same or different, and R′ and R″ can be (i) a straight-chain, branched, or cyclic alkyl group, (ii) a straight-chain, branched, or cyclic alkenyl group, (iii) a straight-chain, branched, or cyclic alkynyl group, (iv) an aryl group, or (v) a heteroaryl group, whereby any of the groups can be unsubstituted or substituted.

As to particular embodiments, the ester can be (1,4-phenylenebis(oxy))bis(ethane-2,1-diyl) dipentanoate (CAS No.: 144482-79-1).

As to particular embodiments, the ester can be (1,4-phenylenebis(oxy))bis(ethane-2,1-diyl) dibutyrate (CAS No.: 144482-78-0).

As to particular embodiments, the solvent (12) can be an alcohol.

As to particular embodiments, the alcohol can be an aliphatic alcohol, an aromatic alcohol, or combinations thereof.

As to particular embodiments, the solvent (12) can be a single compound.

As to other particular embodiments, the solvent (12) can be a mixture of two or more compounds. As to particular embodiments, the solvent (12) can be a mixture of two or more of the illustrative solvents (12) described above.

Without being bound by any particular theory of operation, it is believed that within the instant reversible color-changing system (9), depending upon the temperature of the color-changing system (9), the developer (11) can interact with the solvent (12) to form a solvent-developer complex, whereby this interaction is determined, at least in part, by the affinity of the developer (11) for the solvent (12).

Following, it may be hypothesized that a visible color change can be linked to a competition between the leuco dye (10) and the solvent (12) for complexing with the developer (11), whereby the developer (11) forms a complex with the molecule(s) which it has a greater affinity for.

It should be understood that once a complex forms, the complex is stable until an amount of energy which is sufficient to destabilize the complex is input into the system, thereby dissociating the components of the complex.

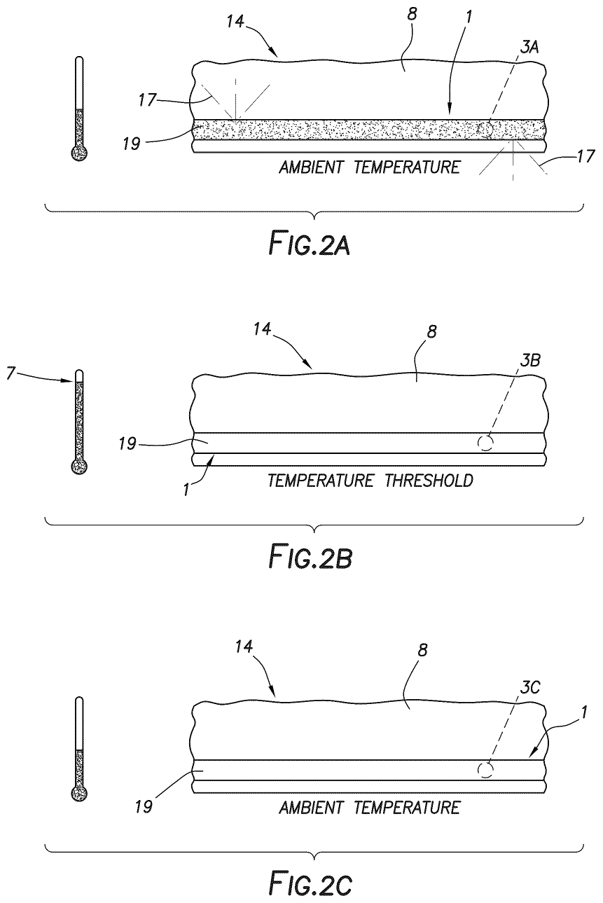

Now referring primarily to FIGS. 2A, 3A, 4A, and 4B, relating to the instant thermochromic indicator (1), prior to use, the reversible color-changing system (9) can be “activated” for use, such as by exposure to a preselected activation temperature (16) at which the developer (11) can have a higher affinity for the leuco dye (10) than for the solvent (12), thus resulting in the formation of the visibly-colored dye-developer complex (13).

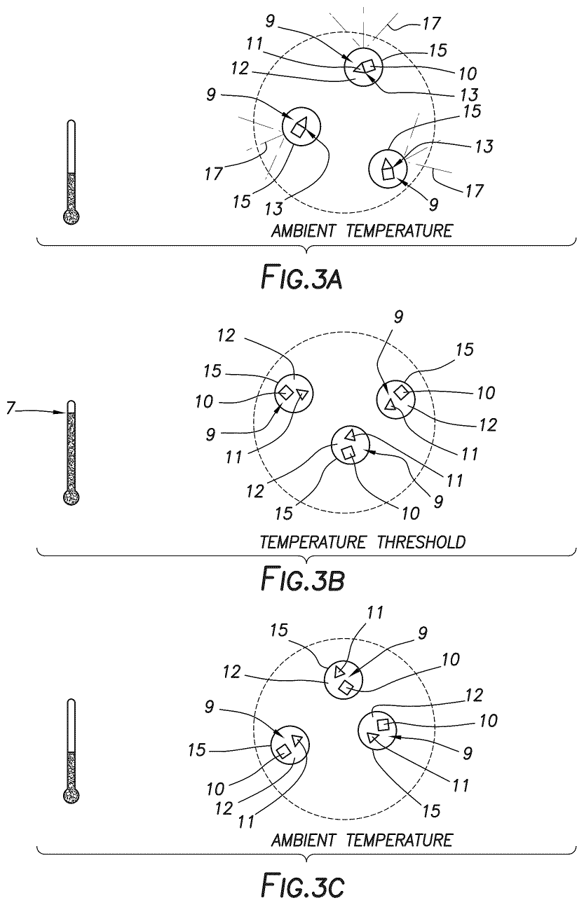

Now referring primarily to FIGS. 2B, 2C, 3B, and 3C, in use, upon exposure to the preselected temperature threshold (7), the developer (11) can have a greater affinity for the solvent (12) than for the leuco dye (10) and accordingly, the developer (11) can dissociate from the leuco dye (10) and subsequently form a solvent-developer complex. When complexed with the solvent (12), the developer (11) can be precluded from interacting with the leuco dye (10); correspondingly, the leuco dye's the lactone ring can be closed and the leuco dye (10) can be colorless.

### Color Memory

As mentioned above, the instant reversible color-changing system (9) can be susceptible to a temperature-modulated color change. Furthermore, the instant reversible color-changing system (9) can have a color-memory property whereby after dissociation of the visibly-colored dye-developer complex (13) upon exposure to the preselected temperature threshold (7), the dye (10) and the developer (11) can remain dissociated upon a decrease in temperature from the temperature threshold (7), for example to a temperature lesser than or below the temperature threshold (7) (such as ambient temperature); hence, the visible color change, for example from colored to colorless, can be retained at temperatures lesser than or below the temperature threshold (7). Correspondingly, the thermochromic indicator (1) can effectively record exposure to the preselected temperature threshold (7), which may be in contrast to a conventional thermometer which may only indicate the current temperature and may not indicate temperatures to which the thermometer was exposed prior to exposure to the current temperature.

The instant reversible color-changing system (9) can include a coloration temperature (which may be synonymous with the preselected activation temperature (16)) at which the color-changing system (9) changes from a colorless state to a visibly-colored state (17). Also, the instant reversible color-changing system (9) can include a decoloration temperature (which may be synonymous with the preselected temperature threshold (7)) at which the color-changing system (9) changes from the visibly-colored state (17) to the colorless state.

Significantly, the coloration and decoloration temperatures of the instant reversible color-changing system (9) can be different, meaning that the coloration temperature can be discrete from the decoloration temperature. For example, the coloration temperature can be less than the decoloration temperature.

Consequently, the color-memory property of the instant reversible color-changing system (9) can facilitate retention of the colorless state upon a decrease in temperature from the decoloration temperature to a temperature lesser than or below the decoloration temperature, thus recording exposure to the decoloration temperature. Additionally, the color-memory property of the instant reversible color-changing system (9) can facilitate retention of the visibly-colored state (17) upon an increase in temperature from the coloration temperature to a temperature greater than or above the coloration temperature.

As to particular embodiments, the coloration temperature can differ from the decoloration temperature by at least about 50 Celsius degrees, meaning that the coloration temperature can be at least about 50 Celsius degrees lesser than the decoloration temperature.

As to particular embodiments, the coloration temperature can differ from the decoloration temperature by at least about 55 Celsius degrees, meaning that the coloration temperature can be at least about 55 Celsius degrees lesser than the decoloration temperature.

As to particular embodiments, the coloration temperature can differ from the decoloration temperature by at least about 60 Celsius degrees, meaning that the coloration temperature can be at least about 60 Celsius degrees lesser than the decoloration temperature.

As to particular embodiments, the coloration temperature can differ from the decoloration temperature by at least about 65 Celsius degrees, meaning that the coloration temperature can be at least about 65 Celsius degrees lesser than the decoloration temperature.

As to particular embodiments, the coloration temperature can differ from the decoloration temperature by at least about 70 Celsius degrees, meaning that the coloration temperature can be at least about 70 Celsius degrees lesser than the decoloration temperature.

As to particular embodiments, the coloration temperature can differ from the decoloration temperature by at least about 75 Celsius degrees, meaning that the coloration temperature can be at least about 75 Celsius degrees lesser than the decoloration temperature.

As to particular embodiments, the coloration temperature can differ from the decoloration temperature by at least about 80 Celsius degrees, meaning that the coloration temperature can be at least about 80 Celsius degrees lesser than the decoloration temperature.

As to particular embodiments, the coloration temperature can differ from the decoloration temperature by at least about 85 Celsius degrees, meaning that the coloration temperature can be at least about 85 Celsius degrees lesser than the decoloration temperature.

As to particular embodiments, the coloration temperature can differ from the decoloration temperature by at least about 90 Celsius degrees, meaning that the coloration temperature can be at least about 90 Celsius degrees lesser than the decoloration temperature.

As to particular embodiments, the coloration temperature can differ from the decoloration temperature by at least about 95 Celsius degrees, meaning that the coloration temperature can be at least about 95 Celsius degrees lesser than the decoloration temperature.

As to particular embodiments, the coloration temperature can differ from the decoloration temperature by at least about 100 Celsius degrees, meaning that the coloration temperature can be at least about 100 Celsius degrees lesser than the decoloration temperature.

As to particular embodiments, the decoloration temperature can be associated with the melting point of the reversible color-changing system (9), and the coloration temperature can be associated with the freezing point of the reversible color-changing system (9). Accordingly, the instant reversible color-changing system (9) can include (i) a melting point at which the reversible color-changing system (9) changes from a visibly-colored state (17) to a colorless state, and (ii) a freezing point at which the reversible color-changing system (9) changes from the colorless state to the visibly-colored state (17).

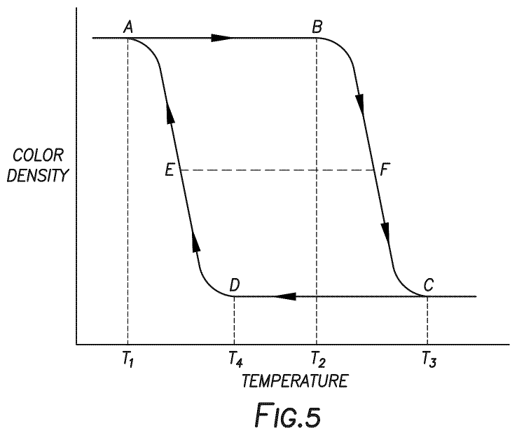

Hysteresis characteristics of a particular embodiment of the instant reversible color-changing system (9) having the color-memory property can be described by illustrating the dependence of color density on temperature. Now referring primarily to FIG. 5, they axis shows the color density and the x axis shows the temperature. The color density of the reversible color-changing system (9) changes with temperature along the curve in the direction shown by the arrow marks. Point A indicates the color density at the maximum temperature T₁ for achieving the completely colored state (whereby T₁ is the complete coloration temperature). Point B indicates the color density at the maximum temperature T₂ for retention of the completely colored state (whereby T₂ is the decoloration initiation temperature). Point C indicates the color density at the minimum temperature T₃ for achieving a completely decolored or colorless state (whereby T₃ is the complete decoloration temperature). Point D indicates the color density at the minimum temperature T₄ for retention of the completely decolored or colorless state (whereby T₄ is the coloration initiation temperature).

Again referring primarily to FIG. 5, while both the completely colored state and the completely decolored or colorless state can exist between T₂ and T₄, the state retained is dependent upon the state previously achieved. For example, if the completely colored state was previously achieved upon exposure to T₁, the completely colored state will be retained until exposure to a temperature equal to or greater than T₂. Alternatively, if the completely decolored or colorless state was previously achieved upon exposure to T₃, the completely decolored or colorless state will be retained until exposure to a temperature equal to or lesser than T₄.

As to particular embodiments, the colored state or the decolored or colorless state can be retained upon exposure to temperatures between about 50 Celsius degrees to about 100 Celsius degrees from the temperature at which the colored state or the decolored or colorless state was achieved. Said another way, the length of segment EF shown in FIG. 5, which represents the temperature range width indicating the degree of hysteresis or hysteresis range or hysteresis window ΔH, can be in a range of between about 50 Celsius degrees to about 100 Celsius degrees.

As but one illustrative example relating to the instant thermochromic indicator (1), upon exposure to the preselected activation temperature (16), the reversible color-changing system (9) can undergo a visible color change and be completely colored at T₁. Following, the completely colored state can be retained upon an increase in temperature, as the visibly-colored dye-developer complex (13) remains stable until temperature T₂ is reached. Upon exposure to the preselected temperature threshold (7), the reversible color-changing system (9) can undergo a visible color change and be completely decolored or colorless at T₃. Subsequently, the completely decolored or colorless state can be retained upon a decrease in temperature, as the dye (10) remains dissociated from the developer (11) until temperature T₄ is reached.

As to particular embodiments, T₁ may, but need not necessarily, be a temperature lesser than about 0° Celsius. For example, T₁ may, but need not necessarily, be a temperature between about −5° Celsius to about −25° Celsius.

T₂ can be a temperature which is associated with the heat welding of the roofing membrane segments (3)(4), and can depend upon the heat transfer characteristics of the particular roofing membrane material to be welded.

As to particular embodiments, T₂ may, but need not necessarily, be a temperature greater than about 50° Celsius. For example, T₂ may, but need not necessarily, be a temperature between about 50° Celsius to about 90° Celsius.

As to particular embodiments, a roofing membrane (14), such as one comprising polyvinyl chloride (PVC) or thermoplastic polyolefin (TPO), may have a welding temperature of about 135° Celsius to about 150° Celsius; correspondingly, the reversible color-changing system (9) may be formulated to have a T₁ of about −10° Celsius and a T₂ of (i) about 67° Celsius to about 70° Celsius (such as for hot or warm weather applications) or (ii) about 40° Celsius to about 45° Celsius (such as for cold or cool weather applications).

### Microcapsules

As stated above, the instant reversible color-changing system (9) is contained, meaning that the dye (10), the developer (11), and the solvent (12) are continuously kept within a physical proximity which allows interaction between the components. Additionally, by being contained, the reversible color-changing system (9) is separated from the external environment, which may damage or destroy the color-changing system (9).

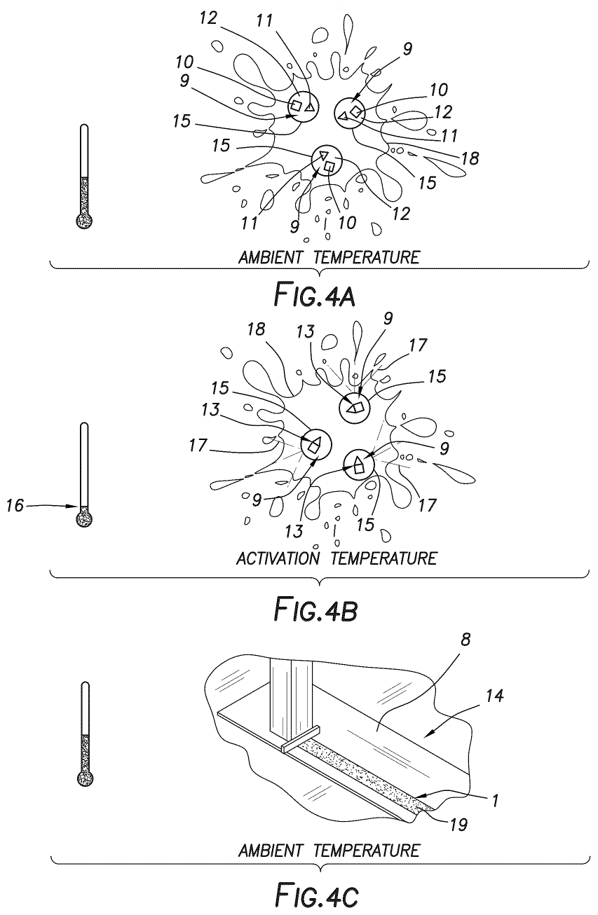

Now referring primarily to FIGS. 3A through 4B, as to particular embodiments, the reversible color-changing system (9) can be encapsulated within a capsule (or microcapsule) (15) to provide a corresponding encapsulated color-changing system (9), whereby the capsule (15) can have a diameter in a range of between about 500 nanometers to about 50 microns, depending upon the embodiment. As to particular embodiments, the instant capsules (15) can have a mean diameter of between about 1 micron to about 3 microns.

The capsule wall which forms the capsule (15) around the reversible color-changing system (9) can be formed from any of a numerous and wide variety of polymers, such as melamine formaldehyde resin (CAS No.: 9003-08-01); CYMEL® 385; polyurethane resin (CAS No.: 9009-54-5); acrylic resin, or the like.

Of note, the capsule wall need not rupture or burst for the visible color change to occur, which may be in stark contrast to conventional temperature-sensitive capsules which require that their wall rupture or burst for a visible color change to occur. For example, conventional temperature-sensitive capsules may include a color former and a color developer, at least one of which is encapsulated to physically separate it from the other, thereby precluding the color former and the color developer from interacting. Following, the capsule wall must rupture or burst to permit the color former and the color developer to be within a physical proximity which allows interaction between the components, resulting in formation of the visibly-colored dye-developer complex. For example, upon rupturing or bursting of the capsules, the color former is released therefrom, contacts and reacts with the color developer, and forms a colored product which can be visually detected.

Concerning the instant use, the foregoing means that it is not required or necessary for the capsule wall which contains the instant reversible color-changing system (9) to rupture or burst for the instant thermochromic indicator (1) to be activated for use; thus, the visibly-colored dye-developer complex (13) can form and be contained within the capsule (15).

Similarly, the foregoing means that it is not required or necessary for the capsule wall which contains the instant reversible color-changing system (9) to rupture or burst for the instant thermochromic indicator (1) to undergo a visible color change resulting from dissociation of the visibly-colored dye-developer complex (13) upon exposure to the preselected temperature threshold (7). Correspondingly, the dissociated dye (10) and developer (11) can be contained within the capsule (15) and precluded from interacting with one another to form the dye-developer complex (13).

As to particular embodiments, it can be required that the capsule wall does not rupture or burst for a visible color change to occur. In other words, the visible color change can only occur if the capsule wall remains intact, thereby functioning to contain the reversible color-changing system (9).

The properties of the capsule wall, such as its composition, rigidity, flexibility, wall thickness, size (corresponding to the diameter of the capsule or microcapsule), etc., can be chosen to result in an encapsulated reversible color-changing system (9) which visibly changes color at the preselected temperature threshold (7), which can be chosen according to the particular circumstances, including the particular roofing membrane (14) to be welded.

As to particular embodiments, the thermochromic indicator (1) can include a plurality of populations of encapsulated reversible color-changing systems (9), whereby each population has a characteristic preselected temperature threshold (7) to which it reacts to provide a visible color change.

### Coating

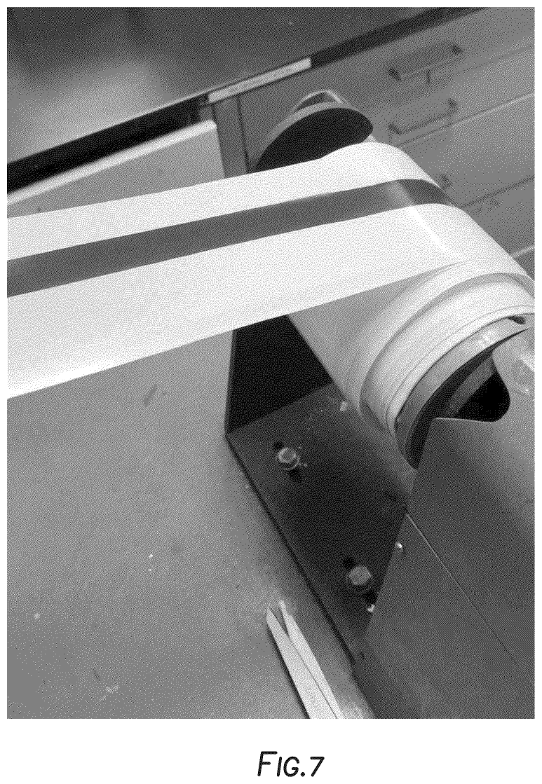

As to particular embodiments of the thermochromic indicator (1), the encapsulated reversible color-changing system (9) can be incorporated into a coating. Now referring primarily to FIGS. 4A through 4C, and 6 through 8, as but one illustrative example, the encapsulated reversible color-changing system (9) can be incorporated into an ink (18).

As to particular embodiments, the ink (18) can be selected from the group including or consisting of: flexographic inks, gravure inks, offset inks, and screen inks. The ink (18) can be water-based, solvent-based, UV-curable, wet, dry, or combinations thereof, depending upon the application.

As to particular embodiments, the ink (18) can be specifically formulated for application to a substrate via printing, such as printing onto a substrate configured as a roofing membrane (14).

The weight percentage of the instant capsules (15) containing the reversible color-changing system (9) in a particular embodiment of an ink (18) which may be useful for printing on a roofing membrane (14) can be in a range of between about 5-50%.

The weight percentage of the instant capsules (15) containing the reversible color-changing system (9) in a particular embodiment of an ink (18) which may be useful for printing on a roofing membrane (14) can be in a range of between about 15-20%.

As to particular embodiments, following printing onto a roofing membrane (14), the ink (18) can be relatively quickly or immediately cured, such as by UV curing or solvent evaporation, and/or dried; accordingly, the roofing membrane (14) with the thermochromic indicator (1) printed thereon can be relatively quickly or immediately packaged, such as coiled into a roll.

### Roofing Membrane Weld Indicator

As stated above, the instant thermochromic indicator (1) can be used with a method for visually determining whether a roofing membrane seam (2) formed by overlapping edge portions of upper and lower roofing membrane segments (3)(4), namely an upper roofing membrane segment edge portion (5) and a lower roofing membrane segment edge portion (6), has been sufficiently heated to a preselected temperature threshold (7) to weld adjacent surfaces of the edge portions (5)(6) and correspondingly, seal the roofing membrane seam (2).

The roofing membrane (14) can be formed from a wide variety of thermoplastic and/or thermosetting materials which may be heat welded. As illustrative examples, thermoplastic materials can include PVC, thermoplastic olefin (TPO), polyethylene, polypropylene, chlorinated polyethylene (CPE), chloro-sulphinated polyethylene (CSPE), or polyisobutylene (PIB). As illustrative examples, thermosetting materials can include ethylene propylene diene monomer (EPDM), butyl rubber, or neoprene.

As to particular embodiments, the roofing membrane (14) can be a single-ply roofing membrane.

As but one non-limiting example, the roofing membrane (14) can be a Sikaplan single-ply PVC roofing membrane, obtainable from Sika Corporation, 100 Dan Road, Canton, MA 02021.

As but a second non-limiting example, the roofing membrane (14) can be a Sarnafil single-ply PVC roofing membrane, obtainable from Sika Corporation, 100 Dan Road, Canton, MA 02021.

As but a third non-limiting example, the roofing membrane (14) can be a SURE-FLEX™ PVC roofing membrane, obtainable from Carlisle SynTec Systems, Carlisle, PA 17013.

The instant thermochromic indicator (1) can be coupled to, directly coupled to, connected to, directly connected to, or integrated with the roofing membrane (14) adjacent and substantially parallel to a longitudinal edge. As to particular embodiments, the thermochromic indicator (1) can be incorporated into a strip to provide a thermochromic indicator strip (19) (whether solid, dashed, dotted, or the like) positioned proximate the edge.

As to particular embodiments, the thermochromic indicator strip (19) can be disposed a relatively short distance inward from the edge of the roofing membrane (14) such that it can be generally laterally centered over the roofing membrane seam region created by the overlapping edge portions (5)(6).

Now referring primarily to FIGS. 1A and 1B, upper and lower roofing membrane segments (3)(4) are illustrated overlaying a roofing substrate (20) (such as metal, concrete, gypsum board, wood board, wood panels, particle board, or the like). Typically, though not necessarily, the roofing substrate (20) can receive a layer of insulation and/or other materials (not shown).

For installation, the lower roofing membrane segment (4) can be rolled into place to overlay the roofing substrate (20). Subsequently, the lower roofing membrane segment (4) can be attached to the roofing substrate (20), such as via adhesion or mechanical attachment. The upper roofing membrane segment (3) can then be rolled into place such that the upper roofing membrane segment edge portion (5) which includes the thermochromic indicator strip (19) overlaps the lower roofing membrane segment edge portion (6), thus upwardly exposing the thermochromic indicator strip (19) so it is visible proximate the roofing membrane seam (2).

It should be appreciated that the entirety of the length of the roofing membrane (14) can include a thermochromic indicator strip (19) along one edge thereof, and that roofing membrane segments (3)(4) can be arranged on the roofing substrate (20) such that the thermochromic indicator strip (19) diposes on the upper surface (21) of the upper roofing membrane segment (3) proximate the roofing membrane seam (2) so that the thermochromic indicator strip (19) is upwardly exposed and visible.

As adjacent surfaces of the overlapping edge portions (5)(6) are heated (specifically, a lower roofing membrane segment upper surface (22) and an upper roofing membrane segment lower surface (23)), heat can pass through the upper roofing membrane segment (3) to the thermochromic indicator (1) located on the upper surface (21) thereof, and cause a visible color change.

It should be appreciated that a certain amount of experimentation may be necessary to determine the precise color shift temperature appropriate for a given composition and thickness of the roofing membrane (14) to indicate a reliable weld because the heat is supplied to the upper roofing membrane segment lower surface (23) and the thermochromic indictor (1) is coupled to the opposing upper surface (21). Thus, not only the characteristics of the roofing membrane material which relate to the achievement of a reliable weld, but also the thickness of the roofing membrane (14) and the heat transfer characteristics therethrough will determine how much heat is transferred through the upper roofing membrane segment (3) to its upper surface (21), and thus to what temperature the upper surface (21) rises and correspondingly, the temperature at which the thermochromic indicator (1) should visibly change color.

To elaborate on the heat welding of the upper and lower roofing membrane segments (3)(4), bonding can generally be achieved via a hot air welder which can be inserted between the adjacent surfaces of the overlapping edge portions (5)(6), whereby the hot air welder can deliver heat to the lower roofing membrane segment upper surface (22) and the upper roofing membrane segment lower surface (23) in a controlled manner to sufficiently heat and soften these surfaces such that when the hot air welder is removed (i.e., slid longitudinally farther along the roofing membrane seam (2)) and pressure is applied by an associated roller or pressure plate, the adjacent surfaces of the overlapping edge portions (5)(6) become welded.

Of course, it should be appreciated that if sufficient heat has been applied to the adjacent surfaces of the overlapping edge portions (5)(6) to seal the roofing membrane seam (2), a sufficient amount of heat will have passed through the upper roofing membrane segment (3) to the thermochromic indicator (1) on the upper surface (21) thereof to achieve a visible color change.

### Method of Application

As stated above, the instant thermochromic indicator (1) can be coupled to, directly coupled to, connected to, directly connected to, or integrated with the roofing membrane (14) adjacent and substantially parallel to a longitudinal edge.

As to particular embodiments, the instant thermochromic indicator (1) can be printed onto the roofing membrane (14).

As to particular embodiments, the instant encapsulated reversible color-changing system (9) can be incorporated into an ink (18) which is subsequently printed onto the roofing membrane (14).

As to particular embodiments, the encapsulated reversible color-changing system (9) can be incorporated into an ink (18) which is printed onto the roofing membrane (14) at the time of manufacture. For example, a slot-die coater can be employed, whereby the slot-die coater can dispense the ink (18) (using a preformed shim) from a narrow slot under air pressure (such as 20-100 psi) from a pressurized reservoir. Depending upon the print head, the ink (18) can be dispensed as one or more continuous lines or can have any desired printable pattern. Relatively quickly or immediately following printing, the ink (18) can be cured, such as via a UV lamp. Relatively quickly or immediately following curing, the roofing membrane (14) can be coiled into a roll for storage, transport, and/or use.

### EXAMPLE 1

The subject matter of this disclosure is now described with reference to the following example. Of note, this example is provided for the purpose of illustration only, and the subject matter is not limited to this example, but rather encompasses all variations which are evident as a result of the teaching provided herein.

In order to test whether a particular embodiment of the instant thermochromic indicator (1) described herein could be used for visually determining whether a sufficient amount of heat has been applied thereto, an encapsulated reversible color-changing system (9) was developed and incorporated into an ink (18).

In particular, the thermochromic indicator (1) included a microencapsulated reversible color-changing system (9) having the color-memory property as described above, comprising about 5-20% w/w 7-[4-(diethylamino)-2-ethoxy phenyl]-7-(1-ethyl-2-methyl indol-3-yl)furo[3,4-b]pyridin-5-one (CAS No.: 69898-40-4) as the dye, about 10-30% w/w 4-[2-(4-hydroxyphenyl)-4-methylpentan-2-yl]phenol (CAS No.: 6807-17-6) as the developer, about 30-60% w/w (1,4-phenylenebis(oxy))bis(ethane-2,1-diyl) dipentanoate (CAS No.: 144482-79-1) as the solvent, and about 10-30% w/w CYMEL® 385 as the capsule wall resin, whereby the microencapsulated reversible color-changing system (9) was prepared as taught in U.S. Pat. Nos. 8,883,049, 9,175,175, and 9,695,320, each of which is hereby incorporated by reference herein. The microcapsules (15) comprised a mean diameter of between about 1 micron to about 3 microns.

The microencapsulated reversible color-changing system (9) was incorporated into a UV-curable flexographic ink (18), whereby the weight percentage of the microcapsules (15) within the ink (18) was about 15 to 20%.

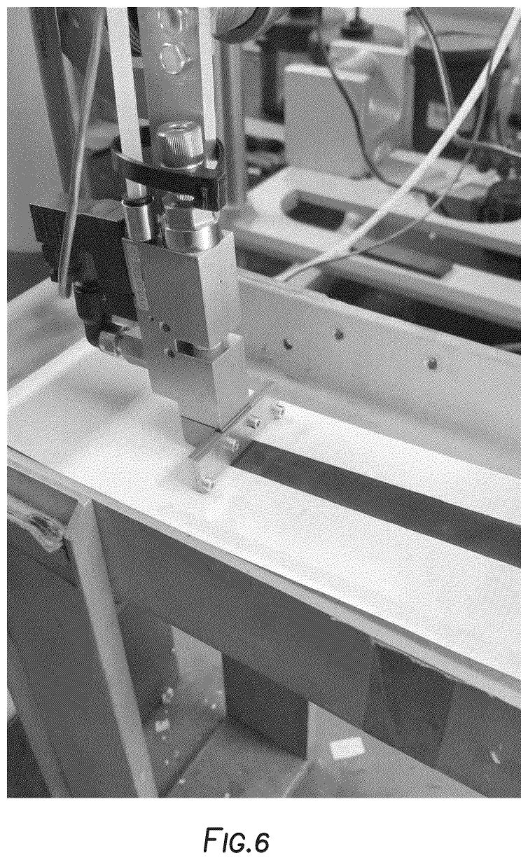

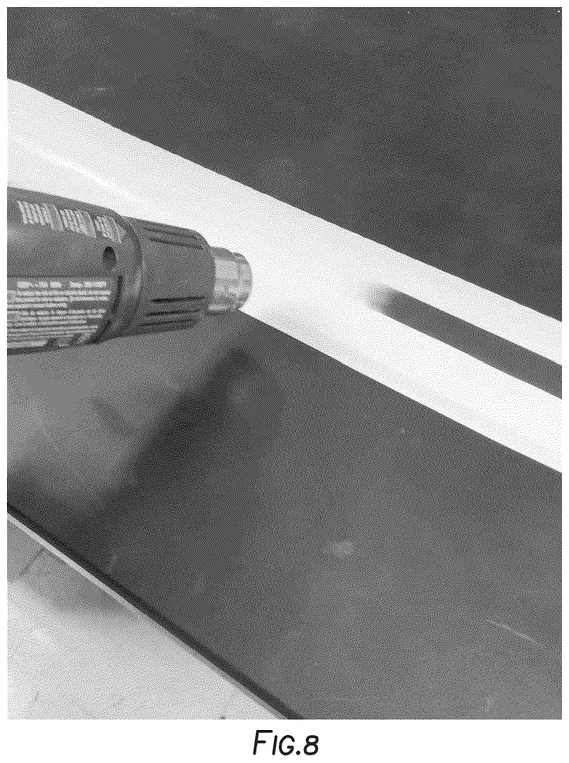

Following, the ink (18) was printed onto a roofing membrane (14) (as shown in FIG. 6), and subsequently heated to a preselected temperature threshold of 65° Celsius with a heat gun from left to right (as shown in FIG. 8). In response to the heat, it can be seen that the thermochromic indictor (1) has undergone a visible color change from blue to colorless.

As can be easily understood from the foregoing, the basic concepts of the present invention may be embodied in a variety of ways. The invention involves numerous and varied embodiments of a thermochromic indicator and methods for making and using such a thermochromic indicator.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “combination” should be understood to encompass disclosure of the act of “indicating”—whether explicitly discussed or not—and, conversely, were there effectively disclosure of the act of “indicating,” such a disclosure should be understood to encompass disclosure of an “indicator” and even a “means for indicating.” Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the thermochromic indicators herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application, if any, provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A temperature indicator for visually determining whether a roofing membrane has been sufficiently heated to a preselected temperature threshold to seal a roofing membrane seam, comprising:
a contained reversible color-changing system comprising:
a dye;
a developer; and
a solvent;
wherein said developer variably interacts with said dye according to the temperature of said color-changing system; and
wherein upon exposure to said temperature threshold, said dye and said developer dissociate, resulting in a visible color change.

2. The temperature indicator of claim 1, wherein said color-changing system records said exposure to said temperature threshold.

3.-4. (canceled)

5. The temperature indicator of claim 1, wherein upon exposure to a preselected activation temperature, said dye and said developer interact to form a visibly-colored dye-developer complex.

6. The temperature indicator of claim 5, wherein said visible color change comprises a change from a visibly-colored state to a substantially colorless state.

7. The temperature indicator of claim 6, wherein said colorless state renders said temperature indicator effectively invisible on said roofing membrane.

8. The temperature indicator of claim 6, wherein said dye comprises a leuco dye.

9. (canceled)

10. The temperature indicator of claim 8, wherein said solvent comprises one or more of a hydrocarbon, a ketone, an ester, or an alcohol.

11.-12. (canceled)

13. The temperature indicator of claim 10, wherein said ester comprises (1,4-phenylenebis(oxy))bis(ethane-2,1-diyl) dipentanoate.

14. The temperature indicator of claim 10, wherein said ester comprises (1,4-phenylenebis(oxy))bis(ethane-2,1-diyl) dibutyrate.

15.-37. (canceled)

38. The temperature indicator of claim 1, wherein said dye, said developer, and said solvent are encapsulated within a capsule to provide an encapsulated reversible color-changing system.

39. (canceled)

40. The temperature indicator of claim 38, wherein said capsule has a mean diameter of between about 1 micron to about 3 microns.

41. The temperature indicator of claim 38, wherein said capsule comprises a capsule wall.

42. The temperature indicator of claim 41, wherein said capsule wall need not rupture for said visible color change to occur.

43. The temperature indicator of claim 41, wherein it is required that said capsule wall does not rupture for said visible color change to occur.

44. The temperature indicator of claim 41, wherein said visible color change can only occur if said capsule wall remains intact.

45.-46. (canceled)

47. The temperature indicator of claim 38, wherein said encapsulated reversible color-changing system is incorporated into an ink.

48. (canceled)

49. The temperature indicator of claim 47, said ink formulated for application to said roofing membrane via printing.

50. The temperature indicator of claim 6, further comprising said roofing membrane;
wherein said color-changing system is coupled to said roofing membrane.

51. The temperature indicator of claim 50, wherein said roofing membrane comprises one or more thermoplastic and/or thermosetting materials.

52. The temperature indicator of claim 50, said color-changing system incorporated into a strip coupled to said roofing membrane proximate a longitudinal edge.
